(19) United States
(12) Patent Application Publication
(10) Pub. No.: US 2026/0133546 A1
(43) Pub. Date: May 14, 2026

(54) SYNTHESIZING DOMAIN-BASED RESPONSES IN INDUSTRIAL AUTOMATION SYSTEMS LEVERAGING GENERATIVE ARTIFICIAL INTELLIGENCE

(71) Applicant: Rockwell Automation Technologies, Inc., Mayfiel Helghts, OH (US)

(72) Inventors: Jonathan A. Mills, Mayfield Heights, OH (US); Zeyang Ye, Austin, TX (US); Jordan C. Reynolds, Austin, TX (US)

(21) Appl. No.: 18/948,130

(22) Filed: Nov. 14, 2024

(51) Int. Cl. G05B 13/02

(52) U.S. Cl. CPC G05B 13/027

(57) ABSTRACT

The technology describes an industrial automation environment with an application service configured to respond to user-submitted queries. The application service is configured to select domains based on the queries, where the domains are directed to specific aspects of the industrial automation environment. The application service is further configured to submit calls to the selected domains and receive responses from each of the selected domains. The application service is further configured to synthesize the responses and provide the synthesized response to a user device for display.

### CROSS REFERENCE TO RELATED APPLICATIONS

This U.S. Patent Application is related to co-pending U.S. Patent Application titled “GUIDED WORKFLOWS AND PREREQUISITE EXTRACTION FOR PERFORMING MAINTENANCE ON AUTOMATION DEVICES,” Attorney Docket Number 2024P-223-US, filed concurrently, the contents of which are incorporated herein in their entirety for all purposes.

This U.S. Patent Application is related to co-pending U.S. Patent Application titled “INDUSTRIAL AUTOMATION GENERATIVE ARTIFICIAL INTELLIGENCE ASSISTANCE INTERFACE WITH INTEGRATED ORGANIZATION CAPABILITIES,” Attorney Docket Number 2024P-224-US, filed concurrently, the contents of which are incorporated herein in their entirety for all purposes.

This U.S. Patent Application is related to co-pending U.S. Patent Application titled “INDUSTRIAL ASSISTANCE PROMPT GENERATION WITH QR CODE DRIVEN DATA RETRIEVAL,” Attorney Docket Number 2024P-225-US, filed concurrently, the contents of which are incorporated herein in their entirety for all purposes.

### TECHNICAL FIELD

The disclosure relates generally to an industrial automation environment providing industrial assistance to users, and more specifically to an application service that leverages domains to respond to user-submitted queries.

### BACKGROUND

In industrial automation environments, operators regularly seek assistance to perform a wide variety of tasks. A wide range of tools and documentation is available to assist these operators. For example, design tools may help operators select appropriate devices for their planned factory, configuration tools facilitate the configuration of these devices, and lifecycle management tools track inventory levels and replacement schedules. Additionally, documentation may assist users in installation and troubleshooting procedures, for example.

Navigating this extensive range of resources to address specific questions can be challenging for operators. Many tasks require accessing multiple tools or resources. For example, when connecting a motor drive to a programmable logic controller (PLC), an operator may need assistance from both motor drive and PLC resources. Furthermore, the compartmentalization of information within existing systems exacerbates these challenges. Different software tools may use separate sets of information, leading to inconsistencies; for instance, two software tools might offer conflicting solutions to the same problem. Consequently, existing systems lack integrated tools that provide consistent, reliable solutions for a variety of needs.

### SUMMARY

The disclosure describes an industrial automation environment that utilizes a software application that selects domains for responding to user-submitted queries. Each domain is directed to a specific aspect of the industrial automation environment; accordingly, the selection of the domains facilitates providing an optimal response to the queries. Upon receiving the responses from the selected domains, the application service synthesizes the responses and provides the synthesized response for display. Accordingly, users may request assistance for a variety of tasks and receive synthesized responses in an integrated environment, thus alleviating the above-described issues.

One example of a computer-implemented method in an implementation includes selecting, by an application service, one or more domains from a number of domains based on a user-submitted query. Each of the domains is directed to a specific aspect of an industrial automation environment. The method further includes generating, by the application service and based on the user-submitted query, a domain-specific request for each of the selected domains. The application service receives responses from each selected domain in response to the domain-specific requests. The application service generates a synthesized response using the responses and provides the synthesized response to a user device for display.

In some implementations, the method further includes submitting, by the application service, a prompt to a generative artificial intelligence model. The prompt includes the user-submitted query, each of the responses, and a request to synthesize the responses. The method may further include receiving, by the application service in response to the prompt, the synthesized response from the generative artificial intelligence model.

In some implementations, at least two domains are selected, and a response is received from each in response to its respective domain-specific request. The application service may generate the synthesized response to include content from the responses from any combination of the selected domains. For example, the synthesized response may include content from all responses, some of the responses, or none of the responses. If, for example, the application service requests a generative artificial intelligence model synthesize the responses, the generative artificial intelligence model may determine which, if any, responses (and/or which parts of the responses) should be included, and integrate those responses or parts into a single, cohesive response (i.e., the synthesized response). However, if the generative artificial intelligence model determines none of the responses should be included, it may revert to using its own training data to generate a complete response and provide it as the synthesized response.

In some implementations, the method further includes incorporating a conversational element into the responses.

In some implementations, the method further includes submitting, by the application service, a domain-selection prompt to a generative artificial intelligence model. The domain-selection prompt includes the user-submitted query and a request to identify relevant domains from the domains for responding to the user-submitted query. The method may further include receiving from the generative artificial intelligence model, by the application service, an identification of the one or more domains.

In some implementations, the method further includes processing, by a natural language processing (NLP) model of the application service, the user-submitted query to identify relevant domains for responding to the user-submitted query.

In some implementations, the method further includes submitting, by the application service, a validation prompt to a generative artificial intelligence model. The validation prompt includes the user-submitted query, the synthesized response, and a request to confirm that the synthesized response appropriately responds to the user-submitted query.

In some implementations, the domain-specific requests each include a request for a domain-specific evaluation procedure. The method may further include receiving, by the application service, the domain-specific evaluation procedure from each of the domains. The method may further include evaluating, by the application service, the synthesized response by performing each received domain-specific evaluation procedure.

In some implementations, the method further includes receiving, by a first domain of the selected domains, the relevant domain-specific request from the application service. The method may further include retrieving, by the first domain, contextual information relevant to the domain-specific request. The contextual information is retrieved from a domain library of the first domain. The method may further include submitting, by the first domain, a domain-specific prompt to a generative artificial intelligence model. The domain-specific prompt includes the contextual information and a request to respond to the domain-specific request based on the contextual information.

In some implementations, the method further includes receiving, by a first domain of the selected domains, the relevant domain-specific request from the application service. The method may further include retrieving, by the first domain, documentation responsive to the domain-specific request from a domain library of the first domain. The method may further include providing, by the first domain, the documentation to the application service in response to the domain-specific request.

These and other features and aspects of various examples may be understood in view of the following detailed discussion and accompanying drawings.

### BRIEF DESCRIPTION OF THE DRAWINGS

FIG. 1 illustrates an industrial automation environment in an implementation.

FIG. 2 illustrates a process flow in an implementation.

FIG. 3 an application service in an implementation.

FIG. 4 a domain in an implementation.

FIG. 5 illustrates a process in an implementation.

FIG. 6 illustrates an operational scenario in an implementation.

FIG. 7 illustrates a computing system suitable for implementing the various operational environments, architectures, environments, processes, scenarios, sequences, and frameworks discussed below with respect to the other Figures.

### DETAILED DESCRIPTION

Industrial automation environments encompass a variety of resources that support operators in designing and maintaining systems. Design tools, such as Rockwell Advisor, help users select suitable components and design system layouts. Configuration tools, like Rockwell's Connected Components Workbench, assist in creating control programming for devices such as programmable logic controllers (PLCs). Monitoring tools, such as Rockwell's GuardianAI, detect anomalies within the automation environment. Additionally, each device model, for example, the PowerFlex 755T, comes with comprehensive documentation covering installation, troubleshooting, configuration, and more. This diverse array of tools and documentation reflects the complexity of industrial automation environments, which involve numerous device types and tasks.

The complexity of industrial automation environments can make it challenging for operators to find the most suitable resources for their needs. They often have to use multiple tools and documents for specific tasks, such as connecting a motor drive to a PLC. Additionally, a single device may have numerous documents within a knowledge base, requiring the operator to choose the appropriate document based on the task at hand. For example, a hardware wiring guide offers instructions for correct wiring, while a troubleshooting guide aids in identifying errors. This fragmented access to resources complicates the operators’ efforts to efficiently build and maintain systems.

Artificial intelligence technology is increasingly being integrated into these various tools to enhance the assistance provided to users. For example, many tools may integrate chatbot features that leverage a generative artificial intelligence model such as a large language model (LLM) to respond to natural-language queries submitted by users. Despite the versatility of generative artificial intelligence models, challenges arise when integrating them with industrial tools. Different tools may have access to different data and documentation, resulting in varying contexts for generative artificial intelligence model queries. Consequently, the same query from an operator may yield different answers across various tools. Furthermore, generative artificial intelligence models tend to hallucinate, especially when provided with insufficient context. Existing industrial tools lack effective means to identify these hallucinations, which may result in suboptimal information being provided to users.

In general, existing systems lack effective integration of various tools and resources, leading to several issues. Operators often need to locate multiple resources to complete tasks, which can be time-consuming and inefficient. This fragmented approach results in inconsistent guidance, as different tools and documents may provide conflicting information. Additionally, inaccuracies arise due to generative artificial intelligence model hallucinations, where generative artificial intelligence model generated responses are based on incomplete or incorrect context.

This disclosure describes an industrial automation environment designed to alleviate the aforementioned issues. This environment includes an application service that receives and responds to user-submitted queries. The application uses domains to provide these responses. Domains, as defined here, are services configured to assist with specific aspects of the industrial environment. The automation environment may encompass multiple domains; for instance, each type of device can have an associated domain, and various tasks (such as generating industrial control logic) can also have associated domains.

Upon receiving a user-submitted query, the application service selects one or more domains that are most relevant to responding to the query. For example, if the query requests help connecting a PowerFlex 755T variable frequency drive to a ControlLogix 5580 controller, domains associated with each of these devices may be selected. The application service may leverage a generative artificial intelligence model, such as a large language model (LLM), to select the domains in some implementations. In other implementations, the application service may utilize built-in natural language processing (NLP) to select the domains. Upon selecting the domains, the application service submits a call (i.e., a domain-specific request) to each of the selected domains requesting a response to relevant aspects of the user-submitted query. Each selected domain provides a response to the application service. The domain may provide the response by submitting a prompt to a generative artificial intelligence model in some instances (for example, when the domain-specific request includes code generation to respond). In other instances, a domain may provide a response without making a generative artificial intelligence model call (for example, where generating the response simply includes retrieving a document to provide to the application service).

Once the application service receives the responses from the selected domains, the application service synthesizes the responses. Synthesizing the responses may include integrating multiple responses from multiple domains into a single response (where multiple domains are selected) and/or may include incorporating a conversational element into the response. The application service may utilize generative artificial intelligence assistance to generate the synthesized response. For example, the synthesized response may include content from all responses, some of the responses, or none of the responses. If, for example, the application service requests a generative artificial intelligence model synthesize the responses, the generative artificial intelligence model may determine which, if any, responses (and/or which parts of the responses) should be included, and integrate those responses or parts into a single, cohesive response (i.e., the synthesized response). However, if the generative artificial intelligence model determines none of the responses should be included, it may revert to using its own training data to generate a complete response and provide it as the synthesized response. In some cases, the generative artificial intelligence model may further incorporate a conversational element into the responses to ensure the synthesized response appears conversational to the user. The application service may also validate the synthesized response by prompting the generative artificial intelligence model to review the response for accuracy. Further, the application service may evaluate the response using domain-specific evaluation procedures provided by the selected domains, as explained in detail herein. These validation and evaluation procedures help to mitigate the chances of providing inaccurate information to users (e.g., by identifying generative artificial intelligence model hallucinations).

The synthesis of domain-based responses allows users to obtain assistance for a wide variety of industrial tasks from a single source (i.e., the application service). This domain selection ensures that users receive the best information and promotes consistency in responses, as the same domain handles similar requests. This technology also enhances efficiency by reducing the need for users to search for appropriate documentation. Additionally, industrial manufacturers can save resources by reducing the need for human assistance. Finally, compute resources are conserved by minimizing data storage redundancy, as related documentation is consolidated within domains rather than being distributed across various tools.

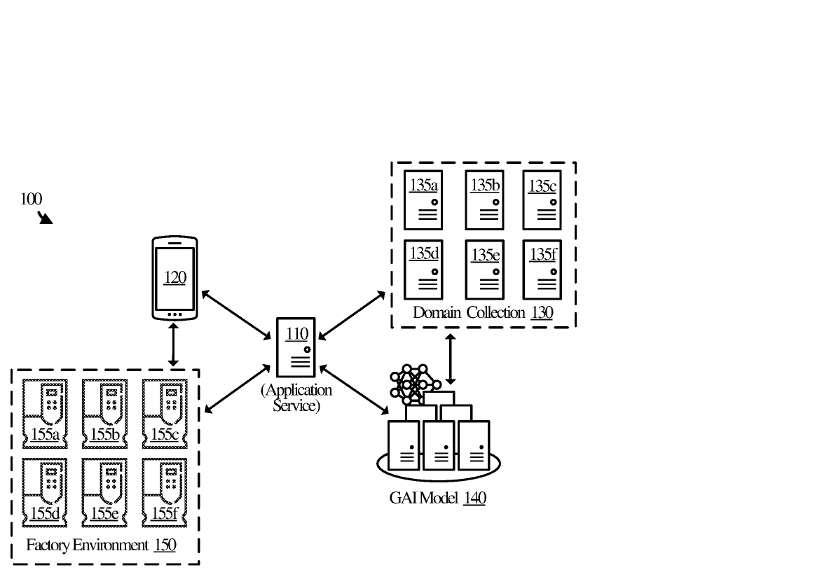

FIG. 1 illustrates industrial automation environment 100 in an implementation. Industrial automation environment 100 includes application service 110, user device 120, domain collection 130, generative artificial intelligence model generative artificial intelligence model 140, and factory environment 150. Application service 110 is in communication with user device 120, domain collection 130, generative artificial intelligence model generative artificial intelligence model 140, and factory environment 150. User device 120 is in communication with application service 110 and factory environment 150. Domain collection 130 is in communication with generative artificial intelligence model generative artificial intelligence model 140.

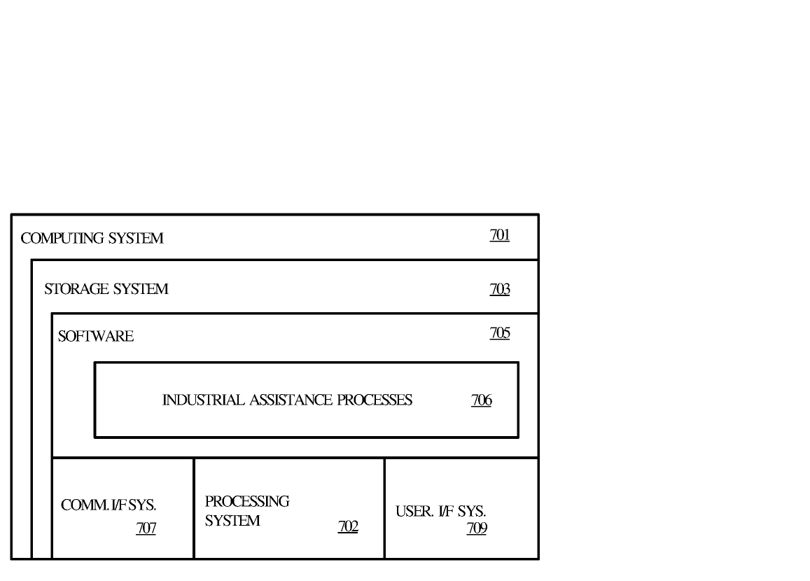

Application service 110 is a service for providing industrial assistance to users. Application service 110 may include software operating on one or more servers, which may be represented by computing system 701 of FIG. 7. In other implementations, application service 110 may be a cloud-based service. Application service 110 may be hosted by an industrial manufacturer in some implementations. Specifically, application service 110 may be provided to assist customers (e.g., a user on user device 120) in the execution of various tasks.

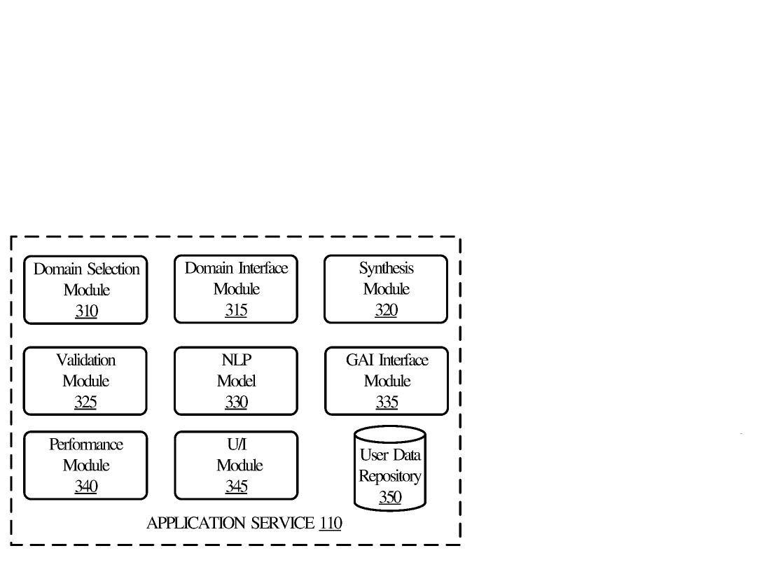

Application service 110 is configured to receive queries submitted from user device 120. Application service 110 selects appropriate domains from domain collection 130 for responding to the submitted queries. Application service 110 is further configured to generate a call (i.e., domain-specific request) for each of the selected domains and receive a response from each of the domains. Application service 110 is further configured to synthesize the responses received from the selected domains and validate the responses. Application service 110 is further configured to provide the synthesized and validated responses to user device 120 for display. During operation, application service 110 may leverage generative artificial intelligence model generative artificial intelligence model 140 to perform various tasks. For example, application service 110 may leverage generative artificial intelligence model generative artificial intelligence model 140 to select appropriate domains in some implementations (although at times domain-selection may be accomplished without generative artificial intelligence model assistance). Each of these operations is discussed in greater detail in relation to FIG. 3 below.

User device 120 is a device utilized by users in industrial automation environment 100 to obtain industrial assistance. User device 120 may be a cell phone, tablet, laptop, human interface module (HIM), personal computer, or any other device capable of interfacing with application service 110. User device 120 may be represented by computing system 701 in FIG. 7. While one user device 120 is shown in FIG. 1 for simplicity, industrial automation environment 100 may include many user devices 120, with multiple users interacting with application service 110.

User device 120 may run device applications that interact with application service 110. For example, device applications running on user device 120 may include an industrial chatbot application, in which a user submits natural language queries to application services and receives the synthesized responses described herein. In some implementations, chatbot features can be built into various device applications (e.g., an industrial design application may have a chatbot options via which a user may submit natural language queries to application service 110). In some implementations, application service 110 may be a web-based application allowing user access via a web-browser. In either case, the user may submit queries and view synthesized responses from application service 110 on a user interface of user device 120.

Domain collection 130 is representative of a collection of domains 135a, 135b, 135c, 135d, 135e, 135f (collectively, “domains 135”) in industrial automation environment 100. While six domains 135 are shown in FIG. 1 for simplicity, it is noted that domain collection 130 may include any number of domains 135. Each domain 135 may include software operating on one or more servers, which may be represented by computing system 701 of FIG. 7.

Domains 135 are services configured to assist users with respect to specific aspects of the industrial automation environment 100. Domains 135 in domain collection 130 may cover many different aspects of industrial automation environment 100. For example, each model of device (e.g., PowerFlex 755T) may have an associated domain directed to that model of device. Various tasks (e.g., industrial control logic generation) may also have an associated domain 135. Accordingly, domain collection 130 as a whole is capable of providing aid in a wide range of needs that arise in industrial automation environment 100.

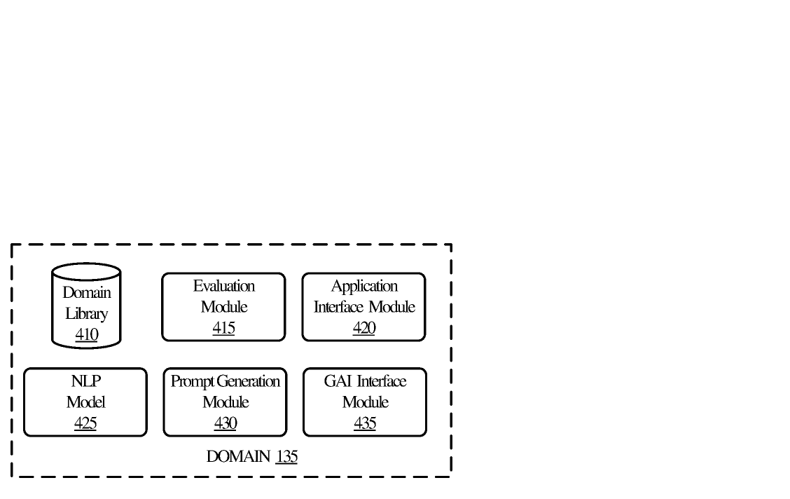

Domains 135 are configured to receive calls (i.e., domain-specific requests) from application service 110. Domains 135 generate responses to the calls using a variety of methods. For example, domains 135 may leverage assistance from generative artificial intelligence model 140 to generate responses. In some cases, domains 135 may utilize a built-in natural language processing (NLP) model to generate the responses. The operations of domains 135 are discussed in greater detail in FIG. 4 below.

Factory environment 150 is representative of an environment executing industrial processes (e.g., manufacturing, packaging, warehousing, etc.). Factory environment 150 includes a wide range of components for performing the industrial processes, including devices 155a, 155b, 155c, 155d, 155e, 155f (collectively “devices 155”) illustrated in FIG. 1. While six devices 155 are shown in FIG. 1 for simplicity, industrial automation environment 100 may include any number of devices 155.

Devices 155 are representative of various devices that may operate in factory environment 150, including, for example, variable frequency drives (VFDs), direct on line controllers, starters, PLCs, and the like. Operators (users) in factory environment 150 perform many tasks associated with devices 155, including selecting the units, designing the system, configuring devices 155, and maintaining devices 155. The users may, in some cases, perform various tasks by interacting with devices 155 directly via user device 120. For example, users may configure and troubleshoot devices 155 via user device 120 connected to the devices 155 (e.g., via a Bluetooth connection, USB connection, near field communication (NFC), etc.).

Generative artificial intelligence model 140 is an artificial intelligence model designed to process and generate natural language text. Generative artificial intelligence model 140 may consist of a system of transformer-based neural networks with a vast number of parameters (weights and balances). It is trained on massive amounts of textual data, enabling it to generate relevant responses based on given prompts or input text. In some implementations, generative artificial intelligence model 140 may be fine-tuned using industrial data, such as product specifications and manuals. Alternatively, generative artificial intelligence model 140 may be a generically trained model that utilizes its general training, along with the context of the prompts, to provide assistance specifically tailored to the industrial automation environment 100. Depending on the implementation, generative artificial intelligence model 140 may be hosted and operated by a third party or by an industrial manufacturer, and it may run from cloud infrastructure or one or more data centers.

Generative artificial intelligence model 140 is configured to receive prompts from application service 110 and domains 135. Prompts from application service 110 may include domain selection prompts requesting generative artificial intelligence model 140 to identify appropriate domains 135 for responding to a user-submitted query, synthesization prompts requesting generative artificial intelligence model 140 to synthesize responses received from domains 135, and validation prompts requesting generative artificial intelligence model 140 to validate a synthesized response. Prompts from domains 135 may include domain-specific prompts requesting generative artificial intelligence model 140 to generate a domain-specific response based on a user submitted query. These various prompts are discussed in greater detail in relation to FIGS. 3 and 4 below. Upon receiving a prompt, generative artificial intelligence model 140 generates a response and provides it to application service 110 or one of domains 135, depending on which element submitted the prompt.

Generative artificial intelligence (GAI) models (also sometimes known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accepts multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

It is noted that FIG. 1 illustrates an implementation that includes one generative artificial intelligence model 140. However, it is noted that in some implementations, industrial automation environment 100 may include multiple generative artificial intelligence models. For instance, one generative artificial intelligence model could handle requests from application service 110, while another generative artificial intelligence model (or several others) manages requests from domains 135.

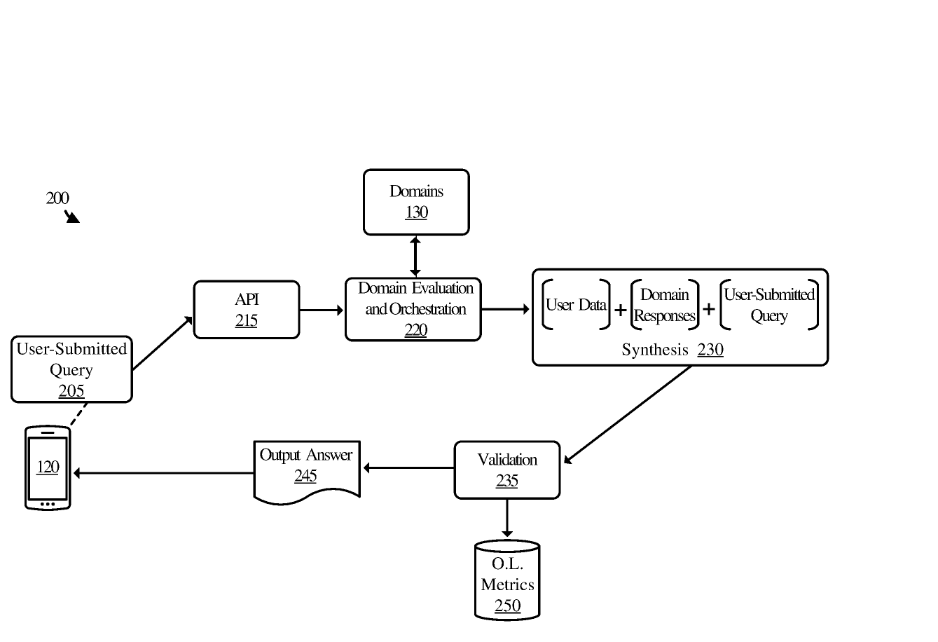

FIG. 2 illustrates process flow 200 in an implementation. Process flow 200 may be implemented by various elements of industrial automation environment 100, as explained below. Process flow 200 includes user device 120, user-submitted query 205, API 215, Domain Evaluation and Orchestration 220, domains 135, Synthesis 230, Validation 235, output answer 245, and outer loop (“O.L.”) metrics 250.

At the start of process flow 200, a user on user device 120 submits user-submitted query 205. User-submitted query 205 may be a text-based question, input by a user on user device 120, requesting industrial assistance. An example user-submitted query 205 may be “How do I connect a PowerFlex 755T to my PLC?”

Next, API 215 processes user-submitted query 205. API 215 serves as an interface between user device 120 and application service 110 (illustrated in FIG. 1). API 215 ensures that user-submitted query 205 is properly formatted and delivered to the downstream components of application service 110 performing Domain Evaluation and Orchestration 220.

Process flow 200 continues with Domain Evaluation and Orchestration 220. Domain Evaluation and Orchestration 220 is representative of functions performed by application service 110 (e.g., domain selection module 310 and domain interface module 315 of FIG. 3). At Domain Evaluation and Orchestration 220, application service 110 selects domains 135 suited for responding to user-submitted query 205. For example, where the user requests help connecting a drive to a PLC, the application service 110 may select a device specific domain for both the drive and the PLC. Upon performing domain selection, application service 110 generates a domain-specific call (i.e., request) for each of the selected domains. Generating the calls involves formatting user-submitted query 205 according to the specific requirements of each domain's API, ensuring that the query is properly structured, and that context is included for each domain 135 to process the request effectively.Domain Evaluation and Orchestration 220 further includes, at application service 110, receiving responses from each of the selected domains 135 in response to the domain specific calls.

When the responses are received from the selected domains 135, process flow 200 continues at Synthesis 230. Synthesis 230 is representative of a function performed by application service 110 (e.g., synthesis module 320 of FIG. 3). At Synthesis 230, application service 110 synthesizes the responses received from the selected domains 135. Application service 110 utilizes user data, the domain responses, and user-submitted query 205 to perform the synthesizing. In one implementation, Synthesis 230 may include providing the user data, domain responses, and user-submitted query 205 to generative artificial intelligence model 140 (illustrated in FIG. 1), with a request to synthesize the domain responses. Where multiple domains were selected at Domain Evaluation and Orchestration 220, the synthesization at Synthesis 230 includes incorporating the responses from each of the selected domains into a single response. Thus, the synthesization request to generative artificial intelligence model 140 may include a request to generate a single response based on the domain responses. Generative artificial intelligence model 140 may utilize user-submitted query 205 to ensure the synthesized response coherently responds to the query.

User data utilized at Synthesis 230 serves as contextual information for generative artificial intelligence model 140, enabling it to generate a response specifically tailored to the user. This data, stored in a user data repository such as user data repository 350 (shown in FIG. 3), may include details such as the user's name, position, organization, location, language preference, and historical interactions, including previously submitted queries and the responses generated for those queries. This user data enables generative artificial intelligence model 140 to personalize the synthesized responses by incorporating various contextual details. For instance, generative artificial intelligence model 140 may incorporate a conversational element into the synthesized response by addressing the user by name or referencing their specific role or organization. Additionally, generative artificial intelligence model 140 can adapt the language and tone of the response based on the user's position or expertise, ensuring that the information is conveyed in an appropriate and easily understandable manner. Generative artificial intelligence model 140 can also leverage historical interactions, referring to previous queries or solutions provided, which helps maintain continuity and build upon past interactions for more accurate and contextually relevant responses.

Once a synthesized response is generated at synthesis 230, process flow 200 continues at validation 235, which is representative of a function performed by application service 110 (e.g., validation module 325 of FIG. 3). Validation 235 includes checking that the synthesized response accurately responds to user-submitted query 205. Validation 235 may include submitting a validation prompt to generative artificial intelligence model 140, where the validation prompt includes the synthesized response, user-submitted query, and a request to confirm that the synthesized response appropriately responds to the user-submitted query. If generative artificial intelligence model 140 responds with an indication that the synthesized response is valid (i.e., that it accurately responds to user-submitted query 205), the synthesized response is provided to user device 120 as Output Answer 245. If generative artificial intelligence model 140 responds with an indication that the synthesized response is invalid (e.g., is technically inaccurate or does not respond to the user-submitted query) the synthesized response is not provided to the user, according to some implementations. Instead, process flow 200 may return to Domain Evaluation and Orchestration 220, in order to attempt to generate a more accurate response. In some implementations, upon receiving the indication of invalidity from generative artificial intelligence model 140, application service 110 may provide an error message to the user on user device 120. Validation 235 mitigates the possibility that generative artificial intelligence model hallucinations containing inaccurate information will be provided to users.

The validity determinations made at Validation 235 may be stored in Outer Loop Metrics 250. Outer Loop Metrics 250 is representative of a repository storing performance information related to process flow 200. Outer Loop Metrics 250 may be utilized (e.g., by performance module 340 of FIG. 3) to assess various aspects of system functionality, including the accuracy and relevance of responses generated by generative artificial intelligence model 140, the efficiency of domain interactions, and the overall user experience.

FIG. 3 illustrates a detailed view of application service 110. Application service 110 includes domain selection module 310, domain interface module 315, synthesis module 320, validation module 325, natural language processing (NLP) model 330, generative artificial intelligence interface module 335, performance module 340, user interface (U/I) module 345, and user data repository 350. While these modules and elements are depicted to describe the generation of synthesized domain-based responses, the functionalities described may be incorporated into more or fewer components, software components, hardware components, firmware components, or a combination without departing from the scope and spirit of the present disclosure.

Domain selection module 310 is configured to select appropriate domains 135 for responding to user-submitted queries. Domain selection module 310 may leverage generative artificial intelligence model 140 to select the appropriate domains in some implementations. This includes generating a domain-selection prompt for generative artificial intelligence model 140, where the domain-selection prompt includes the user-submitted query (e.g., “What is the best device for controlling a CM103 AC motor?”) and a request for a selection of one or more domains that are best suited to responding to the query. Once domain selection module 310 generates the domain-selection prompt, Generative artificial intelligence interface module 335 submits the prompt to generative artificial intelligence model 140 and receives a response from generative artificial intelligence model 140.

In some scenarios, domain selection module 310 may select the appropriate domains 135 without the use of generative artificial intelligence model 140. For example, domain selection module 310 may interface with NLP model 330 to identify appropriate domains. To this end, NLP model 330 is configured to identify certain keywords, which may resolve which domains are appropriate. As an example, a user-submitted query may reference a specific device (e.g., “How do I install my PowerFlex 755T”). In this case, NLP model 330 identifies the keyword “PowerFlex 755T,” and domain selection module 310 selects the PowerFlex 755T based on this identification.

In addition to the techniques described above, domain selection module 310 may utilize other techniques to identify appropriate domains. For example, where user device 120 is connected to a device (e.g., via a USB or Bluetooth connection), domain selection module 310 selects the device-specific domain for the connected device. Domain selection module 310 may be configured to determine which of these techniques to use depending on the situation. For example, domain selection module 310 may determine to leverage generative artificial intelligence model 140 if domains could not be otherwise identified by the NLP model 330 or based on connected devices.

Domain interface module 315 is configured to interface with domains 135 to obtain domain-specific responses to user-submitted queries. Once domain selection module 310 selects the appropriate domains, domain interface module 315 generates a call to each of the selected domains 135 based on the user-submitted query and submits the generated calls to the selected domains. Generating the calls involves formatting the user-submitted query according to the specific requirements of each domain's API, ensuring that the query is properly structured, and that context is included for each domain 135 to process the request effectively. After submitting the calls, domain interface module 315 obtains domain-specific responses from each of the selected domains 135. The generation of domain-specific responses is discussed in greater detail in relation to FIG. 4 below.

Synthesis module 320 is configured to synthesize the domain-specific responses obtained at domain selection module 310. To synthesize the responses, synthesis module 320 may generate a synthesis prompt for generative artificial intelligence model 140, where the synthesis prompt includes the domain responses, the user-submitted query, relevant user data from user data repository 350, and a request to synthesize the domain-specific responses. Generative artificial intelligence interface module 335 submits the synthesis prompt to generative artificial intelligence model 140 and receives a synthesized response from generative artificial intelligence model 140. The synthesized response includes a single integrated response that responds to the user-submitted query. Thus, where multiple domains are selected by domain selection module 310, generative artificial intelligence model 140 generates a single response, which may be based on the multiple domain-specific responses. For example, the synthesized response may include content from all domain-specific responses, some of the domain-specific responses, or none of the domain-specific responses. For example, generative artificial intelligence model 140 may determine, based on the synthesis prompt, which, if any, domain-specific responses (and/or which parts of the domain-specific responses) should be included, and integrate those into a single, cohesive response (i.e., the synthesized response). However, if generative artificial intelligence model 140 determines none of the domain-specific responses should be included, generative artificial intelligence model 140 may revert to using its own training data to generate a complete response to the user submitted query and provide the complete response generated based on its own training data as the synthesized response. In some cases, generative artificial intelligence model 140 may further incorporate a conversational element into the synthesized response to ensure the synthesized response appears conversational to the user. For example, even if a single domain-specific response is used to respond to the user-submitted query, generative artificial intelligence model 140 may modify the domain-specific response to incorporate a conversational element.

The user data utilized in the synthesis prompt serves as contextual information for generative artificial intelligence model 140, enabling it to generate a response specifically tailored to the user. Accordingly, in generating the synthesis prompt, synthesis module 320 retrieves the relevant user data from user data repository 350. This user data may include details such as the user's name, position, organization, location, language preference, and historical interactions, including previously submitted queries and the responses generated for those queries. The user data enables generative artificial intelligence model 140 to personalize the synthesized responses by incorporating various contextual details. For instance, generative artificial intelligence model 140 may incorporate a conversational element into the synthesized response by addressing the user by name or referencing their specific role or organization. Additionally, generative artificial intelligence model 140 can adapt the language and tone of the response based on the user's position or expertise, ensuring that the information is conveyed in an appropriate and easily understandable manner. Generative artificial intelligence model 140 can also leverage historical interactions, referring to previous queries or solutions provided, which helps maintain continuity and build upon past interactions for more accurate and contextually relevant responses.

Validation module 325 is configured to validate the synthesized responses. Validation module 325 may orchestrate both general evaluation procedures and domain specific evaluation according to some embodiments.

To perform general evaluation, validation module 325 confirms that the synthesized response accurately responds to user-submitted query 205. This general evaluation includes generating a validation prompt for generative artificial intelligence model 140, where the validation prompt includes the synthesized response, user-submitted query, and a request to confirm that the synthesized response appropriately responds to the user-submitted query. Generative artificial intelligence interface module 335 submits the validation prompt to generative artificial intelligence model 140 and receives a response from generative artificial intelligence model 140 indicating whether the synthesized response is valid or invalid. To validate the synthesized responses, generative artificial intelligence model 140 may assess confidence levels of different parts of its generated response. Responses with low confidence levels could indicate potential hallucinations, resulting in an invalid response. Generative artificial intelligence model 140 may also assess the relevance of the response in relation to the user-submitted query. If the response includes information that is not sufficiently related to the user-submitted query, the synthesized response may be marked invalid. Conversely, generative artificial intelligence model 140 may determine that the synthesized response is valid if it has a sufficiently high confidence score and relevance.

Validation module 325 is also configured to orchestrate domain-specific evaluation procedures to further validate the synthesized responses. Domain-specific evaluation procedures are tailored to specific types of responses received from domains 135. Descriptions of the domain-specific evaluation procedures may be provided by each domain 135 when it provides a domain-specific response, as discussed in greater detail in FIG. 4 below. As an example, where the synthesized response includes code generated by one of domains 135 (e.g., where the user-submitted query requests code generation for a PLC), the domain-specific evaluation procedure may include attempting to compile the code. Accordingly, validation module 325 performs the domain-specific evaluation procedure by attempting to compile the code or by providing the code to an external application with a request to attempt compilation in various implementations. In another example, a synthesized response could include a configuration for a device such as a variable frequency drive (VFD). A domain-specific evaluation procedure in this case could be to run a simulation of the user’s factory environment with the VFD having that configuration, in order to determine if the generated configuration meets performance standards. Validation module 325 could run this simulation or provide the configuration to an external application to perform the simulation in various implementations. Validation module 325 is configured to validate the synthesized response in the domain-specific evaluation procedures if defined standards are met (e.g., if code successfully compiles or if performance standards are met in a simulation). Validation module 325 invalidates the synthesized response in the domain-specific evaluation procedures if the standards are not met (e.g., code fails to compile, or performance standards are not met in the simulation). It is noted that some domain-specific responses may not have associated domain-specific evaluation procedures (e.g., where the domain-specific response simply includes a retrieved document to provide to the user).

Validation module 325 approves the synthesized response if it is validated in both the general validation procedures and the domain-specific validation procedures. If the synthesized response is approved, U/I module 345 provides the synthesized response to mobile device 120 for display. If validation module 325 does not approve the synthesized response (e.g., because it was invalidated in the general validation or domain-specific evaluation), validation module 325 may generate an error message which U/I module 345 provides to user device 120 for display. In some implementations, validation module 325 may initiate the generation of a new synthesized response, at which point domain selection module 310 may reinitiate the process with the domain selection discussed above.

Natural Language Processing (NLP) model 330 is a specialized model designed to process user-submitted queries by analyzing the natural language within them. Unlike more complex models such as generative artificial intelligence models (e.g., Large Language Models (LLMs)), NLP model 330 may utilize a rules-based approach, making it simpler and more efficient. This model is configured to identify key words or phrases in text strings, such as specific device names (e.g., PowerFlex 755T), through predefined linguistic rules or pattern matching algorithms. For instance, the model could use regular expressions or a dictionary of known device names to scan the input text and extract relevant terms. This approach ensures that the model can accurately identify specific keywords while maintaining a high level of efficiency. By focusing on a targeted task, NLP model 330 can operate with lower computational resources, making it well-suited for integration into application service 110.

NLP model 330 may also play a crucial role in domain selection, as discussed in relation to domain selection module 310. By accurately identifying and extracting device names or other key terms, the model can help determine the appropriate domain 135. Simpler NLP architectures that could perform this functionality include Finite State Machines (FSMs), which parse text and recognize patterns based on predefined states and transitions, and models based on regular expressions, which scan queries for specific patterns corresponding to device names.

Generative artificial intelligence interface module 335 is a module configured to interface with generative artificial intelligence model 140. Generative artificial intelligence interface module 335 performs preprocessing on prompts generated by other modules, such as domain selection module 310, synthesis module 320, and validation module 325, as discussed above. After preprocessing, generative artificial intelligence interface module 335 submits the refined prompts to generative artificial intelligence model 140 for processing. Once generative artificial intelligence model 140 generates responses, Generative artificial intelligence interface module 335 receives these responses and conducts an initial validation, which includes checking for syntax errors and ensuring the responses meet basic correctness criteria before passing them along for further operations.

Performance module 340 is a module designed to assess the overall performance of application service 110. It tracks the validity and invalidity of responses as determined by validation module 325, identifying root causes of performance issues, such as a specific domain 135 generating an unacceptable rate of invalid responses. Performance module 340 may also generate detailed performance reports, which are provided to the operator of application service 110. These reports enable ongoing improvement and refinement of the application service 110.

User interface (U/I) module 345 is a module configured to interface with mobile device 120. U/I module 345 receives user-submitted queries from mobile device 120 and provides synthesized responses and error messages to mobile device 120. U/I module 345 may also perform various other user interface functions, including receiving feedback from users and managing user authentication and continuity.

User data repository 350 is representative of a data repository storing information about users of application service 110. User data stored in user data repository 350 may include details such as the user's name, position, organization, location, language preference, and historical interactions, including previously submitted queries and the responses generated for those queries. The user data may be used to personalize user experience and incorporate conversational elements into synthesized responses, as discussed above in relation to synthesis module 320.

FIG. 4 is a detailed view of domain 135, which is representative of each of domains 135a, 135b, 135c, 135d, 135e, 135f illustrated in FIG. 1. Domain 135 includes domain library 410, evaluation module 415, application interface module 420, NLP model 425, prompt generation module 430, and Generative artificial intelligence interface module 435. While these modules and elements are depicted to describe the operation of domain 135, the functionalities described may be incorporated into more or fewer components, software components, hardware components, firmware components, or a combination without departing from the scope and spirit of the present disclosure.

Domain library 410 is representative of a repository storing documentation associated with each domain. For example, where domain 135 is a domain for an industrial device, domain library 410 may include associated with the device including product specifications, troubleshooting manuals, installation guides, configuration guides, and the like. The documentation may be retrieved by application interface module 420 and provided to application service 110 as a domain-specific response. For example, where the user-submitted query requests help installing a device, an installation guide from domain library 410 may be provided to application service 110 as a domain-specific response. In other scenarios, prompt generation module 430 may utilize documentation from domain library 410 to include in generated prompts, as context for generative artificial intelligence model 140, as discussed further below.

Evaluation module 415 is a module configured to provide domain-specific evaluation procedures to application service 410. Evaluation module 415 may maintain descriptions of appropriate domain procedures that may be used by application service 110 to perform the domain-specific evaluation discussed above. For example, in an industrial control domain, the domain-specific evaluation procedure for generated code may include compiling the code. When domain 135 provides a domain-specific response to application service 110, it may also send the description of the associated domain-specific evaluation procedure. (E.g., where domain 135 returns generated code to application service 110, domain 135 (and in particular, application interface module 420) may provide the recommendation to attempt compilation to application service 110 along with the generated code). Certain domain-specific responses may not have associated domain-specific evaluation procedures, according to some implementations. For example, where a domain-specific response is simply a document retrieved from domain library 410, domain-specific evaluation might not be performed.

Application interface module 420 is a module configured to interface with application service 110. Application interface module 420 receives domain calls from application service 110 (as discussed above with respect to domain interface module 315) and provides generated domain-specific responses (along with their associated domain-specific evaluation procedures) to application service 110.

NLP model 425 is a model designed to process the domain-specific calls by analyzing the natural language within them. NLP model 425 may utilize a rules-based approach, making it simple and efficient. This model is configured to identify key words or phrases in text strings, such as specific assistance requests (e.g., “troubleshoot” or “configuration”), through predefined linguistic rules or pattern matching algorithms. For instance, the model could use regular expressions or a dictionary of various assistance requests to scan the input text and extract relevant terms. This approach ensures that the model can accurately identify specific keywords while maintaining a high level of efficiency. By focusing on a targeted task, NLP model 330 can operate with lower computational resources, making it well-suited for integration into application service 110. NLP model 425 may include a simple architecture such as Finite State Machines (FSMs), which parse text and recognize patterns based on predefined states and transitions, and models based on regular expressions, which scan queries for specific patterns corresponding to assistance request.

NLP model 425 may enable domain 135 to generate domain-specific responses without leveraging generative artificial intelligence model 140 in some scenarios. Specifically, where a domain call includes an assistance request that is identified by NLP 425, application interface module 420 may retrieve a document associated with the assistance request from domain library 410 to provide to application service 110 as a domain-specific response. As an example, if the domain call includes a request from the user to assist in installing a device, NLP model 425 may identify the word “install” in the call, upon which application interface module 420 may retrieve an installation manual from domain library 410 to provide to application service 110 as a domain-specific response. However, in some scenarios, NLP model 425 may not be sufficient to generate a domain-specific response (e.g., where generation such as code generation is called for by the user-submitted query). Accordingly, domain 135 may also (or alternatively) leverage generative artificial intelligence model 140 to generate domain-specific responses according to some implementations (as discussed below in relation to prompt generation module 430 and Generative artificial intelligence interface module 435).

Prompt generation module 430 is a module configured to generate domain prompts to generative artificial intelligence model 140. Domain prompts include the domain call received from application service 110 (which includes the user-submitted query in some implementations) a request to generate a response to the domain call, and relevant context from domain library 410 (if applicable). Accordingly, prompt generation module 430 may retrieve documents and data from domain library 410 to include in the prompts as context. As an example, where the domain prompt includes a request for generating a configuration for a device, prompt generation module 430 may retrieve relevant documents from domain library 410 to include in the prompts (such as device specifications and configuration guides).

Generative artificial intelligence interface module 435 is a module configured to interface with generative artificial intelligence model 140. Generative artificial intelligence interface module 435 performs preprocessing on prompts generated by prompt generation module 430. After preprocessing, Generative artificial intelligence interface module 435 submits the refined prompts to generative artificial intelligence model 140 for processing. Once generative artificial intelligence model 140 generates responses, Generative artificial intelligence interface module 435 receives these responses and conducts an initial validation, which includes checking for syntax errors and ensuring the responses meet basic correctness criteria before passing them along for further operations. Application interface module 420 then provides the generative artificial intelligence generated responses to application service 110 as domain-specific responses.

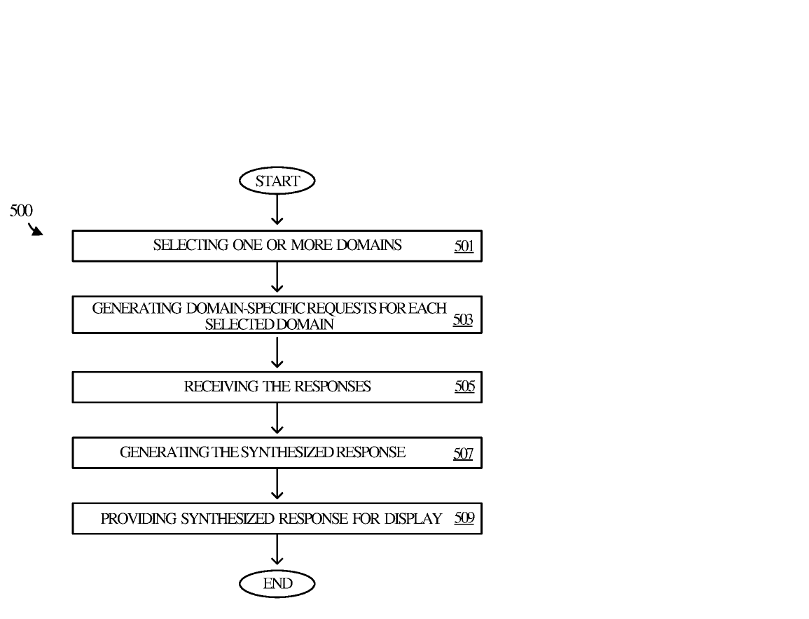

FIG. 5 illustrates a response synthesization process performed by application service 110, represented by process 500. Process 500 is employed by a computing device, an example of which is provided by computing system 701 of FIG. 7. Process 500 may be implemented in program instructions (software and/or firmware) by one or more processors of the computing device. The program instructions direct the computing device to operate as follows, referring parenthetically to the steps in FIG. 5.

To begin, application service 110 selects one or more domains 135 based on a user-submitted query (step 501). Step 501 may be performed specifically by domain selection module 310 of FIG. 3. As discussed above in relation to FIG. 1, each domain 135 is directed to a specific aspect of industrial automation environment 100. In step 501, application service selects those domains 135 that are directed to aspects relevant to the user-submitted question (e.g., a device-specific, domain may be selected when the user-submitted query requests help installing a device).

Application service 110 generates a domain-specific request for each of the selected domains 135 (step 503). Step 503 may be performed specifically by domain interface module 315 of FIG. 3. Generating the calls (i.e., domain-specific requests) may involve, for example, formatting the user-submitted query according to the specific requirements of each domain's API, ensuring that the query is properly structured, and that context is included for each domain 135 to process the request effectively.

Application service 110 receives a domain-specific response from each of the selected domains 135 (step 505). Step 503 may be performed specifically by domain interface module 315 of FIG. 3. Each domain-specific response is generated by the respective domain 135 using various techniques (e.g., by utilizing generative artificial intelligence model 140 or NLP model 425, as discussed in FIG. 4 above).

Application service 110 generates a synthesized response based on the responses from each selected domain (step 507). Step 507 may be performed specifically by synthesis module 320 of FIG. 3. Where multiple domain-specific responses are received, generating the synthesized response may include incorporating each of the domain-specific responses into a single response. Generating the synthesized response may further include incorporating a conversational element into the responses (e.g., referring to the user by name and providing an introduction).

Application service 110 provides the synthesized response for display on user device 120 (step 509). Step 509 may be performed specifically by U/I module 345 of FIG. 3. Upon receiving the synthesized response, the user on user device 120 may submit a follow-up query, at which point, process 500 may be repeated, to generate a synthesized response to the follow-up query.

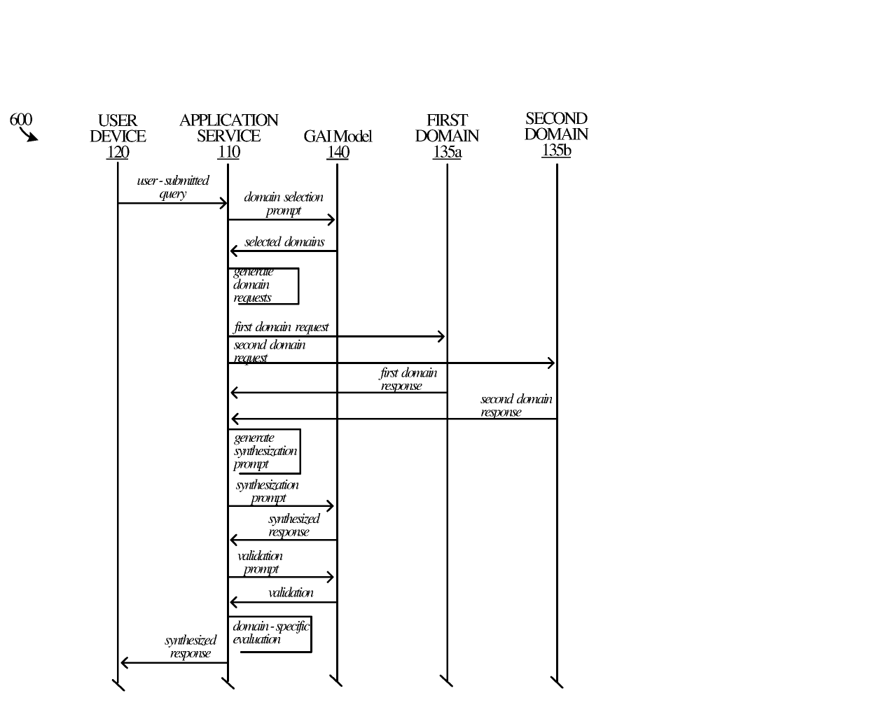

FIG. 6 illustrates an operational sequence of an application of process 500 in the context of industrial automation environment 100 in an implementation, represented by sequence 600. Sequence 600 includes user device 120, application service 110, generative artificial intelligence model 140, first domain 135a, and second domain 135b.

At the start of sequence 600, user device 120 submits a user-submitted query to application service 110. Application service 110 then submits a domain selection prompt to generative artificial intelligence model 140 (as discussed above with respect to step 501 of process 500). The domain selection prompt includes the user-submitted query and a request for a selection of appropriate domains 135 for responding to the user-submitted query. Generative artificial intelligence model 140 selects domains and responds to application service 110 with an identification of the selected domains. In this example, the selected domains are first domain 135a and second domain 135b. It is noted that sequence 600 illustrates an example in which application service 110 leverages generative artificial intelligence model 140 to select domains 135, it is noted that application service 110 may utilize other techniques to perform the selection (as discussed above in relation to domain selection module 310 of FIG. 3).

Once application service 110 receives the selected domains (in this case, first domain 135a and second domain 135b), application service 110 generates a domain-specific request (a first domain request and a second domain request) for each of the selected domains (as discussed above with respect to step 503 of process 500). Application service 110 then submits the first domain request to first domain 135a and the second domain request to second domain 135b. First domain 135a and second domain 135b respond with a first domain response and a second domain response, respectively. First domain 135a and second domain 135b may generate the responses using various techniques depending on the call provided, as explained above in the discussion of FIG. 4. Upon receiving the first domain response and the second domain response, application service 110 generates a synthesization prompt. The synthesization prompt includes the first domain response, the second domain response, the user-submitted query, relevant user data, and a request to synthesize the first domain response and the second domain response, as discussed above in relation to synthesis module 320 of FIG. 3. Application service 110 submits the synthesization prompt to generative artificial intelligence model 140. Generative artificial intelligence model 140 generates the synthesized response and provides the synthesized response to application service 110.

Application service 110 then submits a validation prompt to generative artificial intelligence model 140. The validation prompt includes the synthesized response, the user-submitted query, and a request to validate the synthesized response (as discussed above in relation to validation module 325 of FIG. 3). Generative artificial intelligence model 140 then provides, to application service 110, a validation of the synthesized response. The validation indicates that the synthesized response appropriately responds to the user-submitted query. In other cases, generative artificial intelligence model 140 may provide an indication that the synthesized response is invalid (e.g., has a low confidence score indicative of hallucination, or has a low level of relevance to the user-submitted query). In such cases, application service 110 may reattempt to generate a response by returning to the domain selection procedures at the start of sequence 600 or provide an error message to user device 120.

Returning to sequence 600, when application service 110 receives the validation of the synthesized response, application service 110 performs domain-specific validation procedures. The domain-specific validation procedures may be provided by first domain 135a and second domain 135b the first domain response and the second domain response, respectively. The domain-specific validation procedures define specific procedures recommended for further validation of the domain responses (e.g., attempting to compile generated code). If domain-specific evaluation indicates an error (e.g., code fails to compile), application service 110 may reattempt to generate a response by returning to the domain selection procedures at the start of sequence 600 or provide an error message to user device 120. If no errors are identified during the domain-specific evaluation, application service 110 provides the synthesized response to user device 120 for display.

FIG. 7 illustrates computing system 701, which is representative of any system or collection of systems in which the various applications, processes, services, and scenarios disclosed herein may be implemented. Examples of computing system 701 include, but are not limited to server computers, web servers, cloud computing platforms, and data center equipment, microcontrollers, micro-controller units (MCUs), as well as any other type of physical or virtual server machine, container, and any variation or combination thereof. (In some examples, computing system 701 may also be representative of desktop and laptop computers, tablet computers, and the like.)

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes and implements industrial assistance processes 706, which are representative of the processes discussed with respect to the preceding figures, such as process 500. When executed by processing system 702, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may include a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, microcontroller units, graphical processing units, application specific processors, integrated circuits, application specific integrated circuits, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 703 may be implemented as a single storage device but may also be implemented across multiple storage devices or sub-systems co-located or distributed relative to each other. Storage system 703 may comprise additional elements, such as a controller capable of communicating with processing system 702 or possibly other systems.

Software 705 (including industrial assistance processes 706) may be implemented in program instructions and among other functions may, when executed by processing system 702, direct processing system 702 to operate as described with respect to the various operational scenarios, sequences, and processes illustrated herein. For example, software 705 may include program instructions for implementing industrial assistance processes and procedures as described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for domain-based industrial assistance, the method comprising:
selecting, by an application service, one or more domains from a plurality of domains based on a user-submitted query, wherein each of the plurality of domains is directed to a specific aspect of an industrial automation environment;
generating, by the application service and based on the user-submitted query, a domain-specific request for each of the selected one or more domains;
receiving, by the application service, responses including a response from each of the selected one or more domains based on its respective domain-specific request;
generating, by the application service, a synthesized response using the responses; and
providing, by the application service, the synthesized response to a user device for display.

2. The computer-implemented method of claim 1, wherein the synthesizing the responses comprises:
submitting, by the application service, a prompt to a generative artificial intelligence model, the prompt comprising:
the user-submitted query,
the responses, and
a request to synthesize the responses; and
receiving, by the application service in response to the prompt, the synthesized response from the generative artificial intelligence model.

3. The computer-implemented method of claim 1, wherein:
the selected one or more domains comprise at least two domains,
the responses comprise at least one response from each of the at least two domains, and
the synthesized response comprises content from one or more of the responses.

4. The computer-implemented method of claim 1, wherein generating the synthesized response comprises incorporating a conversational element into the responses.

5. The computer-implemented method of claim 1, wherein the selecting the one or more domains comprises:
submitting, by the application service, a domain-selection prompt to a generative artificial intelligence model, the domain-selection prompt comprising:
the user-submitted query, and
a request to identify relevant domains from the plurality of domains for responding to the user-submitted query; and
receiving from the generative artificial intelligence model in response to the domain-selection prompt, by the application service, an identification of the one or more domains.

6. The computer-implemented method of claim 1, wherein the selecting the one or more domains comprises:
processing, by a natural language processing (NLP) model of the application service, the user-submitted query to identify relevant domains from the plurality of domains for responding to the user-submitted query.

7. The computer-implemented method of claim 1, further comprising:
submitting, by the application service, a validation prompt to a generative artificial intelligence model, wherein the validation prompt comprises:
the user-submitted query,
the synthesized response, and
a request to confirm that the synthesized response responds to the user-submitted query.

8. The computer-implemented method of claim 1, wherein the domain-specific requests each comprise a request for a domain-specific evaluation procedure, the method further comprising:
receiving, by the application service, the domain-specific evaluation procedure from each of the selected one or more domains; and
evaluating, by the application service, the synthesized response by performing each received domain-specific evaluation procedure.

9. The computer-implemented method of claim 1, further comprising;
receiving, by a first domain of the selected one or more domains, the domain-specific request for the first domain from the application service;
retrieving, by the first domain, contextual information relevant to the domain-specific request, wherein the contextual information is retrieved from a domain library of the first domain,
submitting, by the first domain, a domain-specific prompt to a generative artificial intelligence model, the domain-specific prompt comprising:
the contextual information, and
a request to respond to the domain-specific request based on the contextual information.

10. The computer-implemented method of claim 1, further comprising;
receiving, by a first domain of the selected one or more domains, the domain-specific request for the first domain from the application service;
retrieving, by the first domain, documentation responsive to the domain-specific request from a domain library of the first domain; and
providing, by the first domain, the documentation to the application service.

11. A domain-based industrial assistance system, comprising:
one or more processors; and
one or more memories having stored thereon instructions that, upon execution by the one or more processors, cause the one or more processors to:
select one or more domains from a plurality of domains based on a user-submitted query, wherein each of the plurality of domains is directed to a specific aspect of an industrial automation environment,
generate, based on the user-submitted query, a domain-specific request for each of the selected one or more domains,
receive responses including a response from each of the selected one or more domains based on its respective domain-specific request,
generate a synthesized response using the responses, and
provide the synthesized response to a user device for display.

12. The domain-based industrial assistance system of claim 11, wherein the instructions comprise further instructions that, upon execution by the one or more processors, cause the one or more processors to:
submit a prompt to a generative artificial intelligence model, the prompt comprising:
the user-submitted query,
the responses, and
a request to synthesize the responses; and
receive the synthesized response from the generative artificial intelligence model in response to the prompt.

13. The domain-based industrial assistance system of claim 11, wherein:
the selected one or more domains comprise at least two domains,
the responses comprise at least one response from each of the at least two domains, and
the synthesized response comprises content from one or more of the responses.

14. The domain-based industrial assistance system of claim 11, wherein the instructions to generate the synthesized response comprises instructions that, upon execution by the one or more processors, cause the one or more processors to incorporate a conversational element into the responses.

15. The domain-based industrial assistance system of claim 11, wherein the instructions comprise further instructions that, upon execution by the one or more processors, cause the one or more processors to:
submit a domain-selection prompt to a generative artificial intelligence model, the domain-selection prompt comprising:
the user-submitted query, and
a request to identify relevant domains from the plurality of domains for responding to the user-submitted query; and
receive, from the generative artificial intelligence model in response to the domain-selection prompt, an identification of the one or more domains.

16. The domain-based industrial assistance system of claim 11, wherein the instructions to select the one or more domains comprises instructions that, upon execution by the one or more processors, cause the one or more processors to:
process, by a natural language processing (NLP) model, the user-submitted query to identify relevant domains from the plurality of domains for responding to the user-submitted query.

17. The domain-based industrial assistance system of claim 11, wherein the instructions comprise further instructions that, upon execution by the one or more processors, cause the one or more processors to:
submit a validation prompt to a generative artificial intelligence model, wherein the validation prompt comprises:
the user-submitted query,
the synthesized response, and
a request to confirm that the synthesized response responds to the user-submitted query.

18. The domain-based industrial assistance system of claim 11, wherein:
the domain-specific requests each comprise a request for a domain-specific evaluation procedure; and
the instructions comprise further instructions that, upon execution by the one or more processors, cause the one or more processors to:
receive the domain-specific evaluation procedure from each of the selected one or more domains, and
evaluate the synthesized response by performing each received domain-specific evaluation procedure.

19. The domain-based industrial assistance system of claim 11, wherein the one or more memories further comprises:
a first domain of the plurality of domains, the first domain comprising:
a first domain library comprising data specific to the first domain of the one or more domains, and
instructions that, upon execution by the one or more processors, cause the one or more processors to:
receive the domain-specific request for the first domain;
retrieve contextual information relevant to the domain-specific request, wherein the contextual information is retrieved from the first domain library;
submit a domain-specific prompt to a generative artificial intelligence model, the domain-specific prompt comprising:
the contextual information, and
a request to respond to the domain-specific request based on the contextual information
respond to the domain-specific request with a response from the generative artificial intelligence model received in response to the domain-specific prompt.

20. The domain-based industrial assistance system of claim 11, wherein the one or more memories further comprises:
a first domain of the plurality of domains, the first domain comprising:
a first domain library comprising data specific to the first domain of the one or more domains, and
instructions that, upon execution by the one or more processors, cause the one or more processors to:
receive the domain-specific request for the first domain;
retrieve documentation responsive to the domain-specific request from the first domain library; and
respond to the domain-specific request with the documentation.
